(19) United States
(12) Patent Application Publication
(10) Pub. No.: US 2015/0303641 A1
(43) Pub. Date: Oct. 22, 2015

(54) LED PUMPED LASER DEVICE AND METHOD OF USE

(71) Applicant: Colorado School of Mines, Golden, CO (US)

(72) Inventors: Edgar Steven Hill, Denver, CO (US); Charles Gibson Durfee, III, Eldorado Springs, CO (US)

(21) Appl. No.: 14/689,753

(22) Filed: Apr. 17, 2015

Related U.S. Application Data
(60) Provisional application No. 61/980,904, filed on Apr. 17, 2014.

(51) Int. Cl. H01S 3/04; H01S 3/0933; H01S 3/08; H01S 3/16; H01S 3/091; H01S 3/042; H01S 3/102

(52) U.S. Cl. CPC H01S 3/0401; H01S 3/0407; H01S 3/042; H01S 3/0933; H01S 3/1024; H01S 3/1611; H01S 3/1618; H01S 3/1603; H01S 3/1608; H01S 3/1613; H01S 3/1623; H01S 3/1625; H01S 3/0912; H01S 3/08054

(57) ABSTRACT

The present invention provides an apparatus and method for pumping solid-state lasers and amplifiers. More specifically, to a method and apparatus for pumping solid-state lasers and amplifiers using Light Emitting Diode (LED) arrays. In one embodiment, the apparatus comprises a gain medium, a plurality of LEDs in optical communication with the gain medium to excite the gain medium, the plurality of LEDs arranged in an LED array, a driving circuit to energize the LED array, and a thermoelectric cooler to reduce the temperature of the LED array, wherein the gain medium is pumped by the LED array to emit a laser light.

### CROSS REFERENCE TO RELATED APPLICATIONS

This application claims the benefit of U.S. Provisional Patent Application No. 61/980,904 entitled “LED Pumped Lasers and Amplifiers” filed on Apr. 17, 2014, the entire disclosure of which is incorporated by reference herein.

### FIELD

Embodiments of the present invention are generally related to a method and apparatus for pumping solid-state lasers and amplifiers and in particular, to a method and apparatus for pumping solid-state lasers and amplifiers using Light Emitting Diode (LED) arrays.

### BACKGROUND

Since the invention of the laser in 1961, the application of lasers outside of research has been strongly tied to development of pump sources. For example, Ti:sapphire lasers were originally pumped with Ar⁺-ion lasers, but these have been largely been replaced by frequency-doubled, diode-pumped Nd:vanadate lasers (Nd:YVO₄). Arc-lamp and flashlamp-pumped Nd lasers have also been superseded by lasers pumped by high-power diode bars. These replacements have largely been on the merits of superior performance and reliability rather than cost. In many cases, the purchase and maintenance costs of the diode-pumped systems are larger than the technologies they replaced. It has long been a goal to directly pump Ti:sapphire with diode lasers, but there had been a lack of laser sources emitting in the pump 450-550 nm pump band with sufficient power. Although high-power laser diodes very near the peak absorption of Ti³⁺ at 500 nm are not yet available, the recent development of 445 nm diodes at high power (over 1W) has opened up the possibility of directly diode-pumping Ti:sapphire oscillators. The commercial availability of these laser diodes has been driven by the market for display projectors. In the last few years, researchers at the University of Strathclyde in Scotland demonstrated the first direct diode pumped continuous-wave (CW) Ti:sapphire laser oscillator. Subsequently, they demonstrated modelocking by use of intracavity prisms and a saturable Bragg reflector (SBR). Recently, the first Kerr-lens modelocked femtosecond Ti:sapphire laser that was directly diode-pumped was demonstrated.

The cost of advanced laser systems such as ultrafast amplifiers has a major impact on whether new applications can make it out of research and into industry and medicine. Another shift in laser technology can be possible if the advances in high-brightness, high-efficiency and inexpensive LED lighting can be leveraged for laser pumping. While laser diode pumping is well-established (at least for gain media such as Nd and Yb that can be pumped in the near infrared), the LED option is an alternative that has received much less attention. There was some early work on LED- pumped lasers, but the success of laser diode pumping has drawn the attention away from the use of LEDs. The primary challenge of LED pumping is that LED sources are close to Lambertian emitters, and it is relatively difficult to obtain a concentration of the pump light that will result in sufficient gain for an oscillator or amplifier. However, there are several reasons why LED pumping has the potential to make a dramatic impact on the applications of lasers in industry, medicine and research. LED efficiency and cost have dramatically improved recently, owing to the high worldwide demand for efficient lighting. LEDs can deliver high energy output in pulsed mode, and the visible wavelengths available spectrally match the absorption of several important gain media that are not easily pumped with laser diode.

LED-pumped laser systems are anticipated to be sold at significantly reduced cost and system complexity compared to laser systems pumped with laser diodes, arc lamps and flashlamps. Some efforts in LED-pumped lasers have been made, such as U.S. Pat. No. 7,522,651 to Luo (“Luo”). Luo requires spontaneous emission of photons as a result of a population inversion initiated by gain medium excitement with absorption-matching incoherent monochromatic sources such as arrays of LEDs. Luo is silent regarding the use of polarization incoherent light to pump a gain medium, a feature in some embodiments of the invention. Luo is incorporated by reference in its entirety.

Additional background on LED solid-state pumped lasers may be found in “Revisiting of LED pumped bulk laser-first demonstration of Nd-YVO4 LED pumped laser” by Barbet, A. et al, Optics Letters, Vol. 39, No. 23, Dec. 1, 2014 (“Barbet”), incorporated by reference in its entirety. Barbet is silent regarding the use of polarization incoherent light to pump a gain medium, a feature in some embodiments of the invention.

Further general background on LED solid-state pumped lasers may be found in US Statutory Invention Registration No. H2161 by Scheps, incorporated by reference in its entirety.

When pumping a gain medium that has an absorption that depends strongly on the polarization (such as Ti:sapphire and Nd:vanadate), if one does not use a linear polarized light, absorption is much less efficient for half of the pump power. In this disclosure, it is described that by using a semi-polar GaN crystal, e.g., in the LED, one can obtain a linearly polarized light. The prior art, e.g. Luo, does not disclose nor appreciate this because, inter alia, until recently the only means to obtain a polarized light was by placing a polarization filter in front of the LED (which results in a loss of half of the light). We also note that if unpolarized pump light is employed that is directional, for example from a laser diode coupled to a fiber, the transmitted pump light with the more transparent polarization can be reflected back into the crystal after rotating the polarization. This technique cannot be employed with diffusely directed LED light.

Additional information on generating linear polarization light from LEDs may be found in the following documents, each incorporated by reference in entirety: Zhao, Y. et al, “High optical polarization ratio from semipolar (2021) blue-green InGaN/GaN light-emitting diodes,” Applied Physics Letters, 99, 051109 (2011); Schubert, M., et al, “Linearly polarized emission from GaInN light-emitting diodes with polarization-enhancing reflector,” Optics Express, Vol. 15, No. 18, 2007; and Shakya, J. et al, “Polarization of III-nitride blue and ultraviolet light-emitting diodes,” Applied Physics Letters, 86, 091107 (2005).

By way of providing additional background, context, and to further satisfy the written description requirements of 35 U.S.C. §112, the following references are incorporated by reference in their entireties: D. E. Spence, P. N. Kean, and W. Sibbett, “60-fsec pulse generation from a self-mode- locked Ti:sapphire laser,” Opt Lett, vol. 16, no. 1, pp. 42-44, 1991; S. Nakamura, M. Senoh, S.-I. Nagahama, N. Iwasa, T. Matsushita, and T. Mukai, “Blue InGaN-based laser diodes with an emission wavelength of 450 nm,” Appl. Phys. Lett., vol. 76, no. 1, pp. 22-24, 2000; A. R. Bellancourt, U. Mackens, H. Moench, and U. Weichmann, “Blue diode pumped solid-state lasers for digital projection,” Laser Phys., vol. 20, no. 3, pp. 643-648, Feb. 2010; P. W. Roth, A. J. Maclean, D. Burns, and A. J. Kemp, “Directly diode-laser-pumped Ti: sapphire laser,” Opt Lett, vol. 34, no. 21, pp. 3334-3336, 2009; P. W. Roth, A. J. Maclean, D. Burns, and A. J. Kemp, “Direct diode-laser pumping of a mode-locked Ti: sapphire laser,” Opt Lett, vol. 36, no. 2, pp. 304-306, 2011; C. G. Durfee, T. Storz, J. Garlick, S. Hill, J. A. Squier, M. Kirchner, G. Taft, K. Shea, H. Kapteyn, and M. Murnane, “Direct diode-pumped Kerr-lens mode-locked Ti: sapphire laser,” Opt Express, vol. 20, no. 13, pp. 13677-13683, 2012; J. P. Budin, M. Neubauer, and M. Rondot, “Miniature Nd-pentaphosphate laser with bonded mirrors side pumped with low-current-density LED's,” Appl. Phys. Lett., vol. 33, no. 4, p. 309, 1978; B. I. Denker, A. A. Izyneev, I. I. Kuratev, Y. V. Tsvetkov, and A. V. Shestakov, “Lasing in phosphate glasses with high neodymium ion concentrations under pumping with light-emitting diodes,” Soviet journal of quantum electronics, vol. 10, no. 9, p. 1167, 1980; G. I. Farmer and Y. C. Kiang, “Low-current-density LED-pumped Nd:YAG laser using a solid cylindrical reflector,” J. Appl. Phys., vol. 45, no. 3, p. 1356, 1974; M. Saruwatari, T. Kimura, T. Yamada, and J. Nakano, “LiNdP₄O₁₂ laser pumped with an AlₓGa₁₋ₓ As electroluminescent diode,” Appl. Phys. Lett., vol. 27, no. 12, p. 682, 1975; J. Stone, C. A. Burrus, A. G. Dentai, and B. I. Miller, “Nd:YAG single-crystal fiber laser: Room-temperature cw operation using a single LED as an end pump,” Appl. Phys. Lett., vol. 29, no. 1, p. 37, 1976; F. K. Yam and Z. Hassan, “Innovative advances in LED technology,” Microelectronics Journal, vol. 36, no. 2, pp. 129-137, Feb. 2005; R. Haitz, F. Kish, J. Tsao, and J. Nelson, “The case for a national research program on semiconductor lighting,” Optoelectronics Industry Development Association, 1999.

Also, the following references are incorporated by reference in their entireties: D. Zhu, J. Xu, A. N. Noemaun, J. K. Kim, E. F. Schubert, M. H. Crawford, and D. D. Koleske, “The origin of the high diode-ideality factors in GaInN/GaN multiple quantum well light-emitting diodes,” Appl. Phys. Lett., vol. 94, no. 8, p. 081113, 2009; E. Kioupakis, P. Rinke, K. T. Delaney, and C. G. Van de Walle, “Indirect Auger recombination as a cause of efficiency droop in nitride light-emitting diodes,” Appl. Phys. Lett., vol. 98, no. 16, p. 161107, 2011; D. S. Meyaard, G.-B. Lin, J. Cho, E. Fred Schubert, H. Shim, S.-H. Han, M.-H. Kim, C. Sone, and Y. Sun Kim, “Identifying the cause of the efficiency droop in GaInN light-emitting diodes by correlating the onset of high injection with the onset of the efficiency droop,” Appl. Phys. Lett., vol. 102, no. 25, p. 251114, 2013; J. Iveland, L. Martinelli, J. Peretti, J. S. Speck, and C. Weisbuch, “Direct Measurement of Auger Electrons Emitted from a Semiconductor Light-Emitting Diode under Electrical Injection: Identification of the Dominant Mechanism for Efficiency Droop,” Phys. Rev. Lett., vol. 110, no. 17, p. 177406, Apr. 2013; M. J. Cich, R. I. Aldaz, A. Chakraborty, A. David, M. J. Grundmann, A. Tyagi, M. Zhang, F. M. Steranka, and M. R. Krames, “Bulk GaN based violet light-emitting diodes with high efficiency at very high current density,” Appl. Phys. Lett., vol. 101, no. 22, p. 223509, 2012; C.-C. Pan, S. Tanaka, F. Wu, Y. Zhao, J. S. Speck, S. Nakamura, S. P. DenBaars, and D. Feezell, “High-Power, Low-Efficiency-Droop Semipolar (2021) Single-Quantum-Well Blue Light-Emitting Diodes,” Appl. Phys. Express, vol. 5, no. 6, p. 062103, June 2012; A. Pourhashemi, R. M. Farrell, M. T. Hardy, P. S. Hsu, K. M. Kelchner, J. S. Speck, S. P. DenBaars, and S. Nakamura, “Pulsed high-power AlGaN-cladding-free blue laser diodes on semipolar (2021) GaN substrates,” Appl. Phys. Lett., vol. 103, no. 15, p. 151112, 2013; E. Matioli, S. Brinkley, K. M. Kelchner, Y.-L. Hu, S. Nakamura, S. DenBaars, J. Speck, and C. Weisbuch, “High-brightness polarized light-emitting diodes,” Light Sci Appl, vol. 1, no. 8, p. e22, August 2012.

Also, the following references are incorporated by reference in their entireties: P. F. Moulton, “Spectroscopic and Laser Characteristics of Ti:Al₂O₃,”J Opt Soc Am B, vol. 3, no. 1, pp. 125-133, 1986; M. Dymott and A. Ferguson, “Self-mode-locked diode-pumped Cr: LiSAF laser,” Opt Lett, vol. 19, no. 23, pp. 1988-1990, 1994; P. Wagenblast, R. Ell, U. Morgner, F. Grawert, and F. X. Kartner, “Diode-pumped 10-fs Cr ³⁺ :LiCAF laser,” Opt Lett, vol. 28, no. 18, pp. 1713-1715, 2003; U. Demirbas, M. Schmalz, B. Sumpf, G. Erbert, G. S. Petrich, L. A. Kolodziejski, J. G. Fujimoto, F. X. Kartner, and A. Leitenstorfer, “Femtosecond Cr: LiSAF and Cr: LiCAF lasers pumped by tapered diode lasers,” Opt Express, vol. 19, no. 21, pp. 20444-20461, 2011; C. Honninger, R. Paschotta, M. Graf, F. Morier-Genoud, G. Zhang, M. Moser, S. Biswal, J. Nees, A. Braun, and G. Mourou, “Ultrafast ytterbium-doped bulk lasers and laser amplifiers,” Appl Phys B, vol. 69, no. 1, pp. 3-17, 1999; A. Muller, O. B. Jensen, A. Unterhuber, T. Le, A. Stingl, K. H. Hasler, B. Sumpf, G. Erbert, P. E. Andersen, and P. M. Petersen, “Frequency-doubled DBR-tapered diode laser for direct pumping of Ti: sapphire lasers generating sub-20 fs pulses,” Opt Express, vol. 19, no. 13, pp. 12156-12163, 2011; C. Wood, S. Backus, J. Squier, and C. Durfee, “Pumping of Ti:sapphire moves to the blue,” Laser Focus World, September 2012; J. Kvapil, J. Kvapil, B. Perner, J. Kubelka, B. Mánek, and V. Kube\check{c}ek, “Laser properties of yag: Nd, Cr, Ce,” Czechoslovak journal of physics, vol. 34, no. 6, pp. 581-588, 1984; S. M. Kaczmarek, M. Kwaśny, A. O. Matkovskii, D. J. Sugak, Z. Mierczyk, Z. Frukacz, and J. Kisielewski, “Effect of increase of Ce³⁺ ions content after gamma irradiation of Ce and Ce, Nd doped YAG single crystals,” Biuletyn WAT, vol. 8, p. 93, 1996; Y. Li, S. Zhou, H. Lin, X. Hou, and W. Li, “Optical Materials,” Opt Mater, vol. 32, no. 9, pp. 1223-1226, July 2010; J. Walling, O. Peterson, H. Jenssen, R. Morris, and E. O'Dell, “Tunable alexandrite lasers,” Quantum Electronics, IEEE Journal of, vol. 16, no. 12, pp. 1302-1315, 1980; J. Walling, D. Heller, H. Samelson, D. Harter, J. Pete, and R. Morris, “Tunable alexandrite lasers: development and performance,” IEEE Journal of QuantumElectronics, vol. 21, no. 10, pp. 1568-1581, 1985.

Also, the following references are incorporated by reference in their entireties: P. Bado, M. Pessot, J. Squier, G. A. Mourou, and D. J. Harter, “Regenerative amplification in alexandrite of pulses from specialized oscillators,” Quantum Electronics, IEEE Journal of, vol. 24, no. 6, pp. 1167-1171, 1988; S. P. DenBaars, D. Feezell, K. Kelchner, S. Pimputkar, C.-C. Pan, C.-C. Yen, S. Tanaka, Y. Zhao, N. Pfaff, R. Farrell, M. Iza, S. Keller, U. Mishra, J. S. Speck, and S. Nakamura, “Development of gallium-nitride-based light-emitting diodes (LEDs) and laser diodes for energy-efficient lighting and displays,” Acta Materialia, vol. 61, no. 3, pp. 945-951, February 2013; C. Willert, S. Moessner, and J. Klinner, “Pulsed operation of high power light emitting diodes for flow velocimetry,” presented at the 8th International Symposium on Particle Image Velocimetry, 2009; D. S. Bethune, “Dye cell design for high-power low-divergence excimer-pumped dye lasers,” Applied Optics, vol. 20, no. 11, pp. 1897-1899, 1981; and G. Kuhnle, G. Marowsky, and G. A. Reider, “Laser amplification using axicon reflectors,” Applied Optics, vol. 27, no. 13, pp. 2666-2670, 1988.

### Gain and Pumping Distribution

To provide context to the present invention, a discussion of how absorbed light connects to the gain in a laser amplifier is provided. The small signal gain experienced by a pulse passing through an amplifying medium along the z-axis can be expressed as exp[gz] , where the gain coefficient g can be expressed as g=Nᵢₙᵥσ₂₁, σ₂₁ is the stimulated emission cross-section and Nᵢₙᵥ=N₂−(g₂/g₁)N₁ effective inversion number density between levels 1 and 2, accounting for the degeneracies g₁, g₂ of those levels. Depending on the characteristics of the pump source and the method of delivery of light to the gain medium, the inversion density will depend on position. For simplicity, consider the case where the beam being amplified is collimated over its propagation through the gain medium. Here the net small signal gain for the beam can be obtained by integrating over the propagation length L,

G₀=exp[σ₂₁ ∫Nᵢₙᵥ(x,y,z)dz], where integral limits are from 0 to L.

For the collimated input beam, the gain is insensitive to the distribution of the inversion density along the beam, and the gain can be expressed in the convenient form

G₀=exp[Γₛₜₒᵣ/Γₛₐₜ]

where Γₛₐₜ=hv₂₁/σ₂₁ is the saturation fluence of the medium and Γₛₜₒᵣ(x, y) is the stored energy fluence. The stored energy density is related to the intensity distribution of the pump, accounting for the divergence of the pump and its absorption by the gain medium. In the simple limit for a 4 level system where N₁≈0 (fast depopulation of the lasing termination level) and the ground state is not depleted, and the pump duration is comparable to the upper state lifetime τ₂₁, it can be shown that

Nᵢₙᵥ(r)=I(r)ατ₂₁/hv_{P}

where α is the absorption coefficient of the pump and hv_{P}, is the pump photon energy. Finally, the stored fluence can be expressed in terms of an arbitrary pump intensity distribution as Γₛₜₒᵣ(x,y)=/η_{q}ατ₂₁∫I(r)dz, where η_{q}=v_{L}/v_{P} is the so-called quantum defect and the integral limits are from 0 to L. For the case where the pump pulse duration τ_{P} is much less than the fluorescence time, we can approximately set τ₂₁→τ_{P} in this expression.

This simple framework can be used to appreciate the challenges for optical pumping by various sources. One of the most important characteristics of an optical pump source is its divergence. A laser beam with a single lowest-order spatial mode is ideal for longitudinal pumping since it can be focused to a spot and maintain good overlap with the beam being amplified. High-power laser diodes and diode bars are typically single mode in the fast direction (perpendicular to the narrow direction of the emitting facet), but are highly multimode in the slow direction. While the imperfect focusing makes longitudinal pumping more challenging, beam shaping and coupling to multimode fibers are common techniques t o effectively transfer power to the laser crystal. In contrast, the light emitted from a surface emitting LED is sufficiently non-directional that transverse pumping is the best solution for most gain media. The angular distribution from a surface-emitting LED can be approximated as a Lambertian radiator, with an angular dependence that follows cosθ, where θ is the angle from the surface normal. Photonic crystal structures can be used to decrease the angular range of emission[12] somewhat, but even with these structures, the emitted light cannot be concentrated over a substantial volume as a coherent laser beam can. Non-imaging optics can be employed to collect and transfer the light to a smaller spot. By the radiance theorem, this concentration of the local light intensity is accompanied by an increase in the divergence. Therefore, unless the gain medium has an extremely short absorption length, the stored fluence over the absorption distance will be very low. For the most part, the solid-state gain media considered here have absorption lengths that are greater than 2.5 mm, and we will be primarily concerned with transverse pumping.

With transverse pumping, the length of the gain medium in the seed beam direction can be extended to allow the use of a greater number of emitters. The length of the crystal can be limited by several factors such as cost and crystal growth limitations. For high-power pulsed applications, increasing the crystal length also results in higher nonlinear effects (B-integral). For ultrashort pulses, increased dispersion must be balanced in the stretching and compression scheme. The transverse dimensions of the crystal are also limited by considerations of pump uniformity and extraction efficiency. FIG. 1 illustrates a scenario for transverse pumping of a slab that is one absorption length thick. Retro-reflection improves the absorption efficiency, but there is still a gain gradient across the crystal. Dividing the available pump light to pump from both sides leads to improved uniformity, but is no more efficient than single-side pumping. If the transverse crystal dimension in the direction of the pump is much more than the absorption length, there will be an appreciable drop in the gain away from the crystal edge, where the power is difficult to extract. The extraction efficiency will be optimized if the area of the gain medium transverse to the seed beam can be closely matched. See FIG. 1.

While laser diode (LD) bars have some advantages over LEDs for optical pumping of lasers, there are a number of scenarios where LEDs have an advantage. In the following, two approaches are compared.

Spectral coupling efficiency. The narrow emitted spectrum for LD sources can be used to couple the pump much more effectively into the laser medium than arc lamps or flashlamps. This has greatly benefitted the development of many laser systems, especially Nd, Yb, Tm and Er, where there is a good match of the available LD wavelengths to absorption lines. Pumping on a narrow absorption line can lead to short absorption lengths, but also places tight tolerances on the emission wavelength of the LD source. Since the LD emission wavelength depends on the temperature, system cost is driven in part by maintaining the temperature within a narrow range. LEDs in contrast, are available with a wide range of output wavelengths from the near-UV to the near IR. The emission spectra are not as narrow as for LD sources (typically 20 nm), so broader absorption bands must be targeted. It is important to note that the wide wavelength range of LED sources in the visible and UV will allow pumping of important gain media for which high power LDs are expensive or are not available. These include the vibronic media such as Cr³⁺ lasers (alexandrite, Cr³⁺ HUSAF, Cr³⁺:LiSGaF, pump peaks at 420 nm and 590 nm) and notably Ti:sapphire (Ti³⁺, pump peak at 500 nm). Single-emitter laser diodes at 445 nm that are newly available with Watt-level output, but to date diode bars are not available.

LED architectures: The edge emitting architecture of laser diodes allows one beam direction to have good focusing properties, but it also introduces some complications. While it is possible to operate the LD bars in pulsed mode, the peak power out of the LD cannot be much higher than the maximum CW power, being limited by the peak intensity of the beam on the output facet. Cooling of a LD bar must be achieved by heat-sinking on a plane parallel to the emission direction. This makes closely-spaced arrangement of diode bars around the gain medium an engineering challenge. The surface-emitting LEDs are cooled on a surface opposing the emission direction. The broad area of emission results in damage mechanisms that are primarily thermal in nature.

LED efficiency: Intensive investment into research and development has resulted in a dramatic increase in efficiency along with a reduction in cost. See FIG. 2. The highly-efficient GaN based LEDs have lead to the introduction of LEDs into the lighting market. At high current densities, it is observed that the efficiency decreases. The origins of this efficiency droop include thermal effects, current crowding, and Auger recombination. There is recent debate about which mechanisms dominate, though recent work point to the importance of Auger processes that become more likely at high carrier density. Their use of the semi-polar orientation has been shown to lead to LEDs that operate with high efficiency at high current density. Also important for pumping polarized laser media such as alexandrite and Ti:sapphire, they have produced LEDs that produce highly polarized light output.

### Candidate Gain Media for Led Pumping

Titanium⁽³⁺⁾-doped sapphire is an excellent and widely-used gain medium, with an active ion which has a large bandwidth in a host crystal that is hard and has high thermal conductivity. For oscillators, the high saturation intensity and short fluorescence time has led to the use of longitudinal laser pumping by a high-brightness lasers tightly focused to approximately 30 μm in the crystal. The low cost of direct diode pumping has led to the investigation of other ultrafast laser materials, such as Cr:LiSAF and Yb-doped materials. The commercially-available laser diodes at 445 nm have an emitter area of approximately 15 μm×1 μm. Although frequency-doubled diode lasers can be used to pump Ti:sapphire lasers, the simplicity, robustness and cost savings of direct diode pumping is attractive: 445 nm diodes can be less than $400 for a complete double laser package producing 2.2 W. Direct diode-pumped Ti:sapphire lasers have great promise to increase reliability and portability for a new generation of ultrafast laser systems. While direct LD pumping of Ti:sapphire oscillators represents a great advance, there is still a challenge of reducing the footprint and cost for pumping more energetic systems. The disclosure's focus on LED pumping stems in part from the high cost and poor reliability of pump sources for Ti⁽³⁺⁾:sapphire amplifiers.

Ti⁽³⁺⁾:sapphire is not the only gain medium that can benefit from powerful pump sources in the visible. Cerium⁽³⁺⁾-sensitized crystal Ce:Nd:YAG is a viable option. This gain medium has been known for some time. In this disclosure, the first lasing of this material by blue LEDs is achieved. Nd-based lasers have long been the workhorse of industrial and scientific lasers and there might seem to be little need for improvement. However, arc- and flash-lamp pumping remains extremely inefficient, at the 2% wall-plug efficiency level. CW and pulse diode-pumped systems perform better and are more efficient, but are even more expensive than lamp pumping. An LED-pumped system has the potential to be an order of magnitude less expensive than either type of system. Cerium has a very strong absorption band that overlaps well with 450 nm LEDs. There is a rapid, efficient, non-radiative energy transfer to the co-doped Nd ions.

A third example of a gain medium that can benefit from solid-state pumping is alexandrite. Alexandrite has sufficient gain bandwidth to support short pulses, but the advent of Ti:sapphire, with broader bandwidth and lower saturation fluence (higher gain), has relegated alexandrite to a small number of specialized commercial purposes such as skin treatments. However, given an inexpensive and efficient means of pumping, alexandrite could be important for short pulse amplification. The material has strong absorption bands in the blue and yellow, where there are now high LED sources available. Alexandrite has almost 10 times the fluorescence lifetime of Ti:sapphire, allowing for proportionately more energy storage.

### Testing the Limits of Semipolar LEDs for Pulsed Solid State Laser Pumping

It is well established that polarization fields across the quantum well active regions of III-N LEDs grown on the basal c-plane degrade carrier injection and radiative recombination rates, and that devices grown on nonpolar or semipolar planes perform better, particularly at high current density. This is shown in FIG. 3, where the external quantum efficiency (EQE) of state of the art polar and semipolar LEDs are compared. At the current densities and output powers required for optical pumping of solid state lasers, the reduced droop of semipolar LEDs is a clear advantage. The source of the remaining droop may be caused by Auger recombination.

Some solid state gain materials perform better at reduced temperature, which opens the possibility of using LEDs under cryogenic conditions. For example high thermal load leads to strong thermal lensing in laser crystals. Additionally, thermally induced stress leads to stress birefringence in isotropic materials such as YAG. For sapphire in particular, the thermal conductivity increases and the sensitivity to thermal change (dn/dt) decreases at cryogenic temperature, thereby dramatically reducing thermal distortions on the amplified beam. Radiative and nonradiative recombination, dopant ionization, carrier transport and injection efficiency are all temperature dependent. Theoretical calculations also predict some temperature dependence for Auger recombination.

In this disclosure, the limits of LED operation are pushed to scale the power of direct pumping of gain media. Among other things, an LED pumped Ce:Nd:YAG laser is disclosed. Also, aspects relevant to high-power laser pumping are disclosed, to include: the mechanisms of the observed efficiency drop at high current density, techniques for avoiding thermal damage, design and testing of approaches for optimizing the optical coupling of LED light to the gain media, and the demonstration of amplification or lasing in Ce:Nd:YAG, alexandrite and Ti:sapphire.

Some of the advantages of the LED pumped laser device and method include: 1) a significant reduction in cost and operational time compared to state of the art optically pumped laser heads; 2) a major reduction in power supplies and cooling system costs and operational time; 3) the ability to be used in continuous or variable repetition rate pulsed modes without changing the pump source; 4) the ability to be used both in the oscillator and amplifier stages; and 5) the flexibility to offer a wide range of high-power LED wavelengths, and therefore may be applied to a wide range of gain media. The device and method may also be used in high speed photography and high intensity industrial photon processing such as Rapid Thermal Annealing and medical photo therapy and photo drug.

### SUMMARY

A method and apparatus for pumping solid-state lasers and amplifiers is disclosed and in particular, a method and apparatus for pumping solid-state lasers and amplifiers using Light Emitting Diode (LED) arrays is disclosed.

In one embodiment, a solid-state laser device is provided which comprises: a gain medium; a plurality of LEDs in optical communication with the gain medium to excite the gain medium, the plurality of LEDs arranged in an LED array; a driving circuit to energize the LED array; and a cooler to reduce the temperature of the LED array, wherein the gain medium is pumped by the LED array to emit a laser light. In one embodiment, the active ions in the solid-state gain medium are selected from the group consisting of Ce⁽⁺³⁾:Nd⁽⁺³⁾, Ce⁽⁺³⁾:Yb⁽⁺³⁾, Ce⁽⁺³⁾:Er⁽⁺³⁾, Pr⁽⁺³⁾, Ti⁽³⁺⁾ (e.g. Ti:sapphire) and Cr⁽⁺³⁾ (e.g. alexandrite, ruby, or Cr:LiCAF). In one embodiment, the cooler comprises a thermoelectric and microchannel cooler.

In another embodiment, an LED pumped laser system is disclosed, the system comprising: a solid-state gain medium wherein active ions in the gain medium are selected from the group consisting of ⁽⁺³⁾:Nd⁽⁺³⁾, Ce⁽⁺³⁾:Yb⁽⁺³⁾, Ce⁽⁺³⁾:Er⁽⁺³⁾, Pr⁽⁺³⁾, Ti⁽³⁺⁾ and Cr⁽⁺³⁾; a plurality of LEDs arranged in a 2-dimensional planar LED array in optical communication with the gain medium to excite the gain medium; a driving circuit devoid of flash lamps to energize the LED array; a cooler to reduce the temperature of the LED array, the cooler comprising a thermoelectric cooler and a microchannel cooler; wherein the LEDs emit linearly polarized light; and wherein the gain medium is pumped by the LED array to emit a laser light.

In another embodiment, a method of generating laser light is disclosed, the method comprising: providing a gain medium; arranging a plurality of LEDs in a 2-dimensional planar LED array in optical communication with the gain medium to excite the gain medium; driving the LED array with a driving circuit to energize the LED array; providing a cooler in communication with the LED array to cool the LED array; emitting linearly polarized light by the plurality of LEDs; and pumping the gain medium with the emitted linearly polarized light; wherein laser light is emitted.

The term “laser” and variations thereof, as used herein, refers to a device that emits light through the stimulated emission of electromagnetic radiation.

The term “laser diode”, “LD” and variations thereof, as used herein, refers to a laser electrically-pumped by a semiconductor diode.

The term “laser pumping” and variations thereof, as used herein, means the act of transferring energy into the gain medium of a laser.

The term “lase” and variations thereof means to give off or emit laser light.

The term “light emitting diode”, “light-emitting diode”, “LED” and variations thereof, as used herein, refers to a semiconductor diode that emits light.

The term “gain medium” and variations thereof, as used herein, means a source of optical gain as used in a laser.

The term “Ce” refers to the chemical element Cerium with atomic number 58.

The term “Er” refers to the chemical element Erbium with atomic number 68.

The term “Nd” refers to the chemical element Neodymium with atomic number 60.

The term “Si” refers to the chemical element Silicon with atomic number 14.

The term “Tm” refers to the chemical element Thulium with atomic number 69.

The term “Yb” refers to the chemical element Ytterbium with atomic number 70.

The term “GaN” refers to the chemical compound Gallium Nitride.

The terms “Alexandrite”, “Titanium:Sapphire”, and “Ti:Al₂O₃” refer to a laser gain medium of Titanium-doped Al₂O₃.

The terms “Nd:YAG”, “Nd:Yttrium Aluminium Garnet” and “Nd: Y₃Al₅O₁₂ refer to a laser gain medium of Neodymium-doped Yttrium Aluminium Garnet.

The terms “Ti:Sapphire”, “Titanium:Sapphire”, and “Ti:Al₂O₃” refer to a laser gain medium of Titanium-doped Al₂O₃.

The terms “Ce:Nd:YAG”, “Ce:Nd:Yttrium Aluminium Garnet” and “Ce:Nd: Y₃Al₅O₁₂ refer to a laser gain medium of co-doped, by Cerium⁽³⁺⁾ and Neodymium⁽³⁺⁾, Yttrium Aluminium Garnet.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

This Summary is neither intended nor should it be construed as being representative of the full extent and scope of the present disclosure. The present disclosure is set forth in various levels of detail in the Summary as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claim set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the invention and together with the general description of the invention given above, and the detailed description of the drawings given below, serve to explain the principals of this invention.

FIG. 1 depicts a graph of calculated pump fluence with transverse distance across a crystal, according to the prior art;

FIG. 2 depicts a graph of performance increase and cost decrease of LEDs with time, according to the prior art;

FIG. 3 depicts a graph of external quantum efficiency droop with current density for c-plane and semipolar LEDs, according to the prior art;

FIG. 4 depicts a block diagram of the LED pumped laser device according to one embodiment;

FIG. 5A depicts the mathematical incident power of a Lambertian radiator with ratio of LED radial position to rod radius;

FIG. 5B depicts a first embodiment of an LED array of an LED pumped laser device according to the embodiment of FIG. 4;

FIG. 5C depicts a second embodiment of an LED array of an LED pumped laser device according to the embodiment of FIG. 4;

FIG. 6A depicts a third embodiment of an LED array of an LED pumped laser device according to the embodiment of FIG. 4;

FIG. 6B depicts a forth embodiment of an LED array of an LED pumped laser device according to the embodiment of FIG. 4;

FIG. 7A depicts a fifth embodiment of an LED array of an LED pumped laser device according to the embodiment of FIG. 4;

FIG. 7B depicts a sixth embodiment of an LED array of an LED pumped laser device according to the embodiment of FIG. 4;

FIG. 8A depicts an image of LED array output of an LED pumped laser device according to the embodiment of FIG. 4;

FIG. 8B depicts a graph of external quantum efficiency with LED peak current density;

FIG. 9A depicts a graph of current pulse and photodiode signal with time;

FIG. 9B depicts multimode output beams at a first current density;

FIG. 9C depicts multimode output beams at a second and higher current density;

FIG. 10A depicts the absorption spectra for alexandrite;

FIG. 10B depicts the absorption spectra for Ti:sapphire;

FIG. 10C depicts the absorption spectra for Praeseodymium;

FIG. 11A depicts a graph of LED output power with time, according to the prior art;

FIG. 11B depicts a graph of emitted LED pump energy with time, according to the prior art;

FIG. 11C depicts a graph of emitted LED output power with time, and LED current with time, of an LED pumped laser device according to the embodiment of FIG. 4;

FIG. 12A depicts a flash lamp circuit, according to the prior art;

FIG. 12B depicts one embodiment of the driving circuit element of an LED pumped laser device according to the embodiment of FIG. 4; and

FIG. 13 depicts a block diagram of the LED pumped laser device according to another embodiment, using the driving circuit element of FIG. 12B.

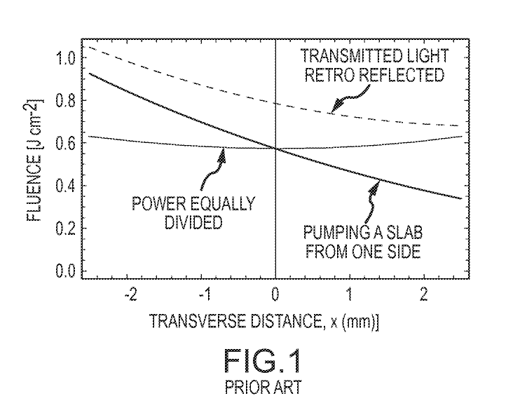

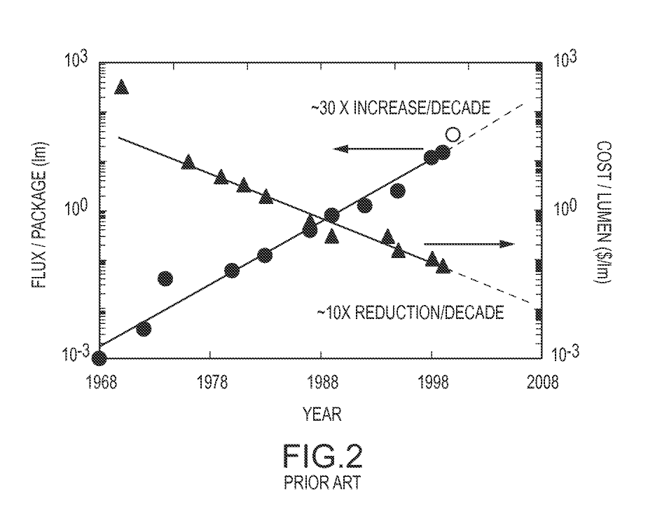

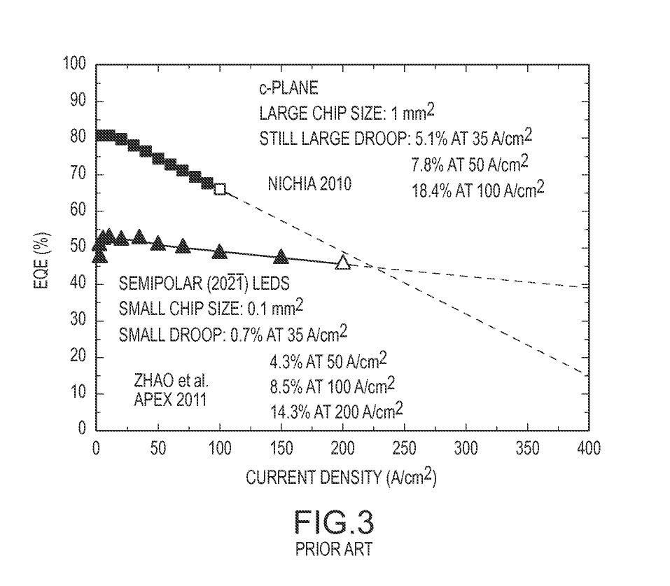

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

To assist in the understanding of the present invention the following list of components and associated numbering found in the drawings is provided herein:

### DETAILED DESCRIPTION

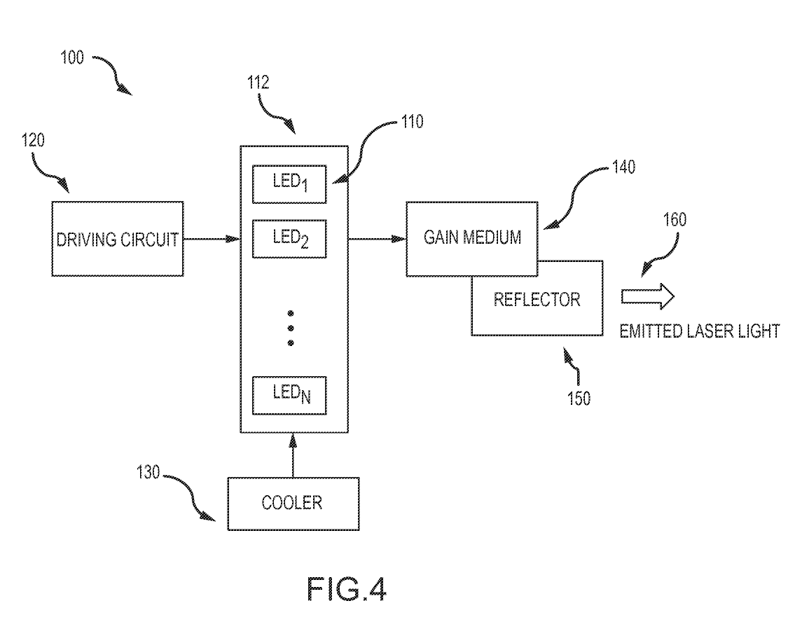

FIG. 4 provides a block diagram of the LED pumped laser device 100 according to one embodiment. The device 100 comprises one or more LEDs 100 arranged in an LED array 112. The one or more LEDs 110 are driven by a driving circuit (aka LED pulsing circuit) 120 and are cooled by cooler 130. The one or more LEDs 110 excite a gain medium 140, wherein emitted light is reflected via reflector 150 thereby producing emitted laser light 160.

In one embodiment, the gain medium 140 is Ce⁽³⁺⁾:Nd⁽³⁺⁾:YAG, so as to include cerium⁽³⁺⁾ ions as a sensitizer for pumping the neodymium⁽³⁺⁾ ions, with absorption in the blue. The absorption by the cerium⁽³⁺⁾ can be quite strong, and the non-radiative cooperative energy transfer to the Nd⁽³⁺⁾ ions is fast and efficient. The relatively long (230 us) lifetime of the metastable state in Nd allows for energy accumulation and storage, while the moderate value for the saturation fluence (˜0.3 J/cm²) results in reasonable gain without requiring large stored energy density. To demonstrate the feasibility of using LED arrays to transversely pump lasers, a Ce⁽³⁺⁾:Nd⁽³⁺⁾:YAG crystal was pumped with 450 nm LEDs. This arrangement shows that the LEDs can be driven with sufficiently high output to achieve lasing.

Generally, the rare earths included in the gain medium are in the 3+ valance state.

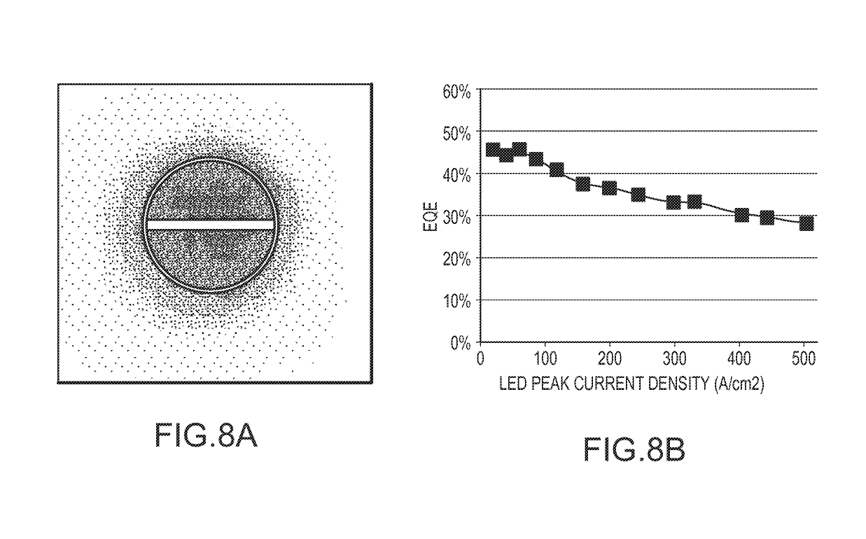

In one embodiment, the LED arrays 112 used are commercially-available, produced by Shenzhen Hanhua Opto Co. (HH-100WB3HB1010-M) operating at 450 nm and rated for 45% EQE with a 45W output with 3.4 A delivered to the array. The array 112 consists of 1.1 mm square emitters arranged in a 24×24 mm array. Electrically, the LED elements 110 are ten (10) columns in parallel, each column consisting of 10 LEDs in series. Therefore the rated operating current density is approximately 30 A/cm². FIG. 8A shows the distribution of light emitted by the array on a screen placed at approximately a 2 cm distance. These LEDs do not have any structure to increase the directionality of emission and have an approximately Lambertian distribution.

In one embodiment, the driving circuit 120 was developed to deliver square current pulses to the array 112. Since driving the array 112 at high current leads to a strong thermal load, a thermoelectric (TE) cooler 130 was added to the back of the array 112. The TE module was water-cooled on the warm side. To reduce the thermal load further, the driving circuit 120 pulsed at 200 μs and at a low duty cycle, typically 1-10%. An integrating sphere with a calibrated Si photodiode power meter was used to measure the average optical power as the pulse current was varied. The current was measured by recording the voltage across a 0.01Ω current-limiting resistor in series with the array. The plot shows that the LED array operates at close to the rated 45% EQE but at higher currents the yield droops. See FIG. 8B.

For this embodiment of the array 112, increasing the current density by a factor of about 17× drops the efficiency to 62% of its initial value. Even with the drop in EQE at high current density, the useful output energy is increased by over 10 times by using pulsed operation (46 mJ). Extrapolating to a higher current density of 1000 A/cm², the EQE for this array would drop to around 14.5%. At this high current density the drop in efficiency would approximately balance the increased current and the total useful energy output would not be significantly higher. Semipolar LEDs have demonstrated EQE up to 50% for current densities of 1000 A/cm². This would represent about 162 mJ of useful energy from this array.

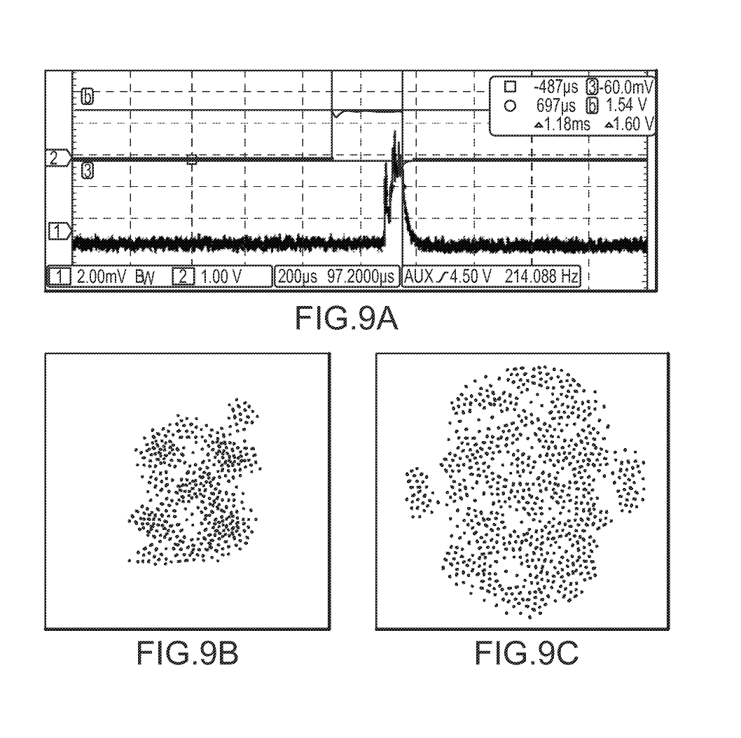

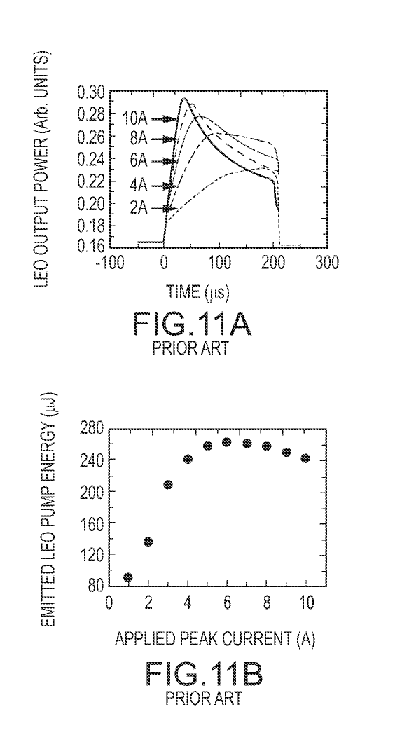

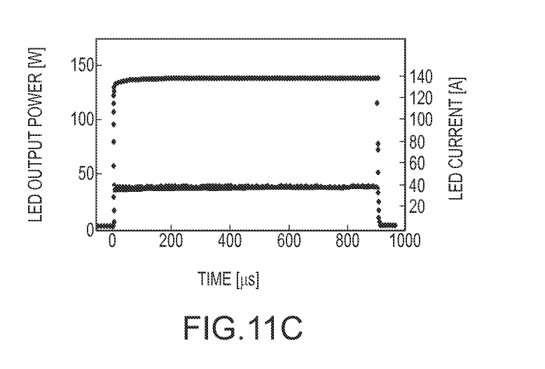

In one embodiment, two arrays 112 are placed at a distance of approximately 4 mm from the 3 mm×50 mm rod on opposing sides. A semi-confocal cavity with a high reflector of 500 mm radius and a flat output coupler (5% transmission) are placed on either side of the rod. The rod was supported by holes in an enclosing aluminum chamber, but was uncooled. An alignment laser was used to verify the alignment of the rod and mirrors. Lasing action was observed with a photodiode (See FIG. 9A) and with a CCD camera (See FIGS. 9B-C). For the pump current of shown in FIG. 9A, the laser was operating at approximately 1.5× over threshold. Relaxation oscillations are seen in the time-dependent waveform. Since the rod area is much larger than the TEM00 mode size (·um), the laser was operating multimode. See FIGS. 11A-C.

These experiments demonstrate the feasibility of using LED arrays to pump solid state lasers. In another embodiment, direct LED pumping of Ti⁽³⁺⁾:sapphire lasers and amplifiers is disclosed.

### Pulsed LED Operational Characteristics

The majority of the testing of LEDs has been under high-current continuous operation. The transient behavior of the LEDs is particularly important for operation for laser pumping. Because the efficiency drops at high current, driving with an approximately rectangular current pulse allows for a greater output energy than, for example, the critically-damped current pulse that is produced by a pulse forming network that drives a flashlamp. In one embodiment, individual LED emitters are mounted into custom arrays, comprising series and parallel operations.

Extracting heat from the LEDs is critical for high repetition rate operation. For example, consider an LED with an EQE of 45% operated at a current density of 1000 A/cm². With a bandgap of 2.75 eV, and a 40% duty cycle the nominal heat load directly at the LED will be 660 W/cm². This is in the range of heat load that may be addressed with microchannel/microfluiding cooling methods. In one embodiment, liquid and 2-phase microchannel cooling techniques are used to manage the heat load. The transient electrical and optical measurements help indicate whether rapid heating during the pulse contributes to the droop in the EQE. A thermal infrared camera may be used to assist in locating local hot spots. A design challenge for laser systems pumped with laser diode bars is that because they use edge emission, the microchannel cooling direction must be oriented perpendicular to the output direction of the pump light. For LEDs, the emission from the surface allows heat extraction around the periphery, which in turn allows for a higher packing density. The current arrays in one embodiment have an element size of 1.1 mm square, and are mounted with a 21% fill factor. In an other embodiment, interconnects are modified to increase the fill factor by at least a factor of 2.

For pumping gain media with a short lifetime, the thermal limitations may be pushed into a different regime. Willert and co-workers explored the operation of LEDs with 1 us duration pulses with a 1% duty cycle. They tested the light output as the peak current was varied up to current densities of 1300 A/cm2. Red LEDs from Philips showed efficiency droop, but there was no sign of damage even at 2200 A/cm2. The maximum peak current was a factor of over 30 times the rated current, indicating that there is substantial room for working with high peak current if the average current is kept to within the rated value. The limits of high peak power operation is a function of the pulse duration and temperature. Operating at high peak current during a 3 us duration is critical for the success of LED pumping of Ti:sapphire.

### Optical Design: Coupling of LED Light to the Gain Media

While LEDs can be efficient for optical emission and can support high current density, the diffuse output of the LEDs presents a challenge for getting this light into the gain medium. The system must not only couple the optical power into the crystal, it also must provide a means for cooling both the crystal and the LEDs. Optical configurations for LED pumping

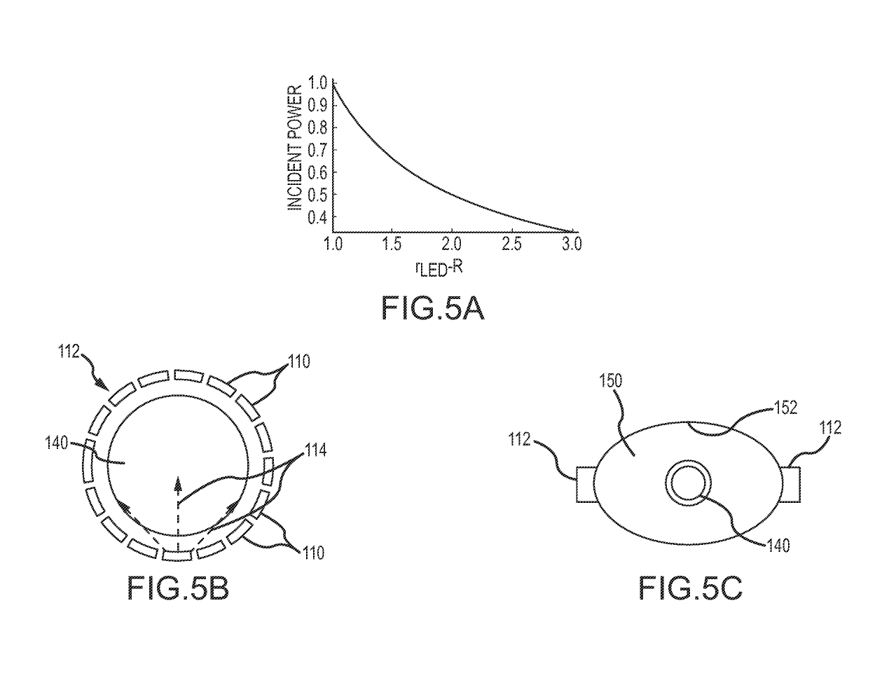

The broad angular emission from the LEDs must be managed. FIGS. 5B and 5C illustrate two options for transverse pumping of laser rods. The most direct approach is to array the LEDs around the perimeter of the cylindrical laser rod. See FIG. 5B. As depicted, a plurality of LEDs 110 are arranged in a circular array 112 around gain medium 140. Each LED depicted in FIG. 5B represents a close-packed array that runs the length of the exposed laser rod. Each LED array 110 emits LED emitted light 114. Depending on the number of LED array groups distributed azimuthally around the rod and the diameter of the surface containing the LEDs, there will be a varying amount of surface area between the LEDs. This surface area is to be highly reflective, preferably a diffusely reflective surface. While some LEDs have photonic crystal structures on the output surface to increase the directionality of the emission, the emission is inherently non-directional. For estimating purposes, we assume here a Lambertian radiation pattern, with the power emitted over a cosθ distribution (angle measured relative to the surface normal). With this emission pattern, there are two principle design approaches. The first is to position the LEDs as close as possible to the laser crystal so as to absorb the pump light on the first pass. FIG. 5A shows the power incident on a cylindrical rod as a function of the distance of the LED from the rod. This calculation assumes a point emitter and does not account for the spatial extent of the emitter. The emission along the rod axis is assumed to strike the surface. What is clear from this simple calculation is that it is the ratio of the LED distance from the central axis to the rod radius that is the most important factor. If liquid cooling of the rod will require a separate flow tube, this scheme may work only if the rod diameter is sufficiently large. For example, with a 6 mm rod diameter, a 1 mm gap between the rod and a 1 mm thick flow tube would allow 75% of the light to reach the rod surface. With a high fill factor, many LEDs can be arrayed around the periphery, allowing for high-energy pumping. In another embodiment, a close-coupled diffuse reflecting chamber is used, commonly used for lamp pumped systems. See FIG. 5C. As depicted in FIG. 5C, an LED array 112 are mounted in opposing locations to a gain medium 140, the gain medium 140 positioned with a reflector 150 comprising reflector surfaces 152. This approach will be most appropriate for thinner rods, where the absorption length is comparable to or less than the rod diameter. Multiple reflections from the highly reflective, diffuse surfaces allow for light transmitted through the rod to encounter the rod again. Diffuse, highly reflective materials, such as ceramics or fluoropolymer-based compounds, can have reflectivities in the 97-99% range. With this high reflectivity, a larger LED radius can be chosen, allowing for more LEDs and a higher total pump energy. A variation of this method has been reduced to practice, where a diffuse reflecting pump chamber was fabricated from Teflon, with an inner diameter of 25 mm. In this embodiment, two 10×10 arrays of 450 nm LEDs were used, each with a maximum output optical pulse energy of 140 mJ in a 900 μs duration square pump pulse. With a 3 mm diameter, 50 mm length Ce:Nd:YAG rod, 4 mJ output pulse duration with the laser operating in quasi-CW mode was obtained. Pumping with 810 nm LED arrays, 8 mJ output energy was obtained. Substantially greater output energy may be obtained with chamber reflection efficiency than was possible in this embodiment (90% for blue, 77% for the near infrared).

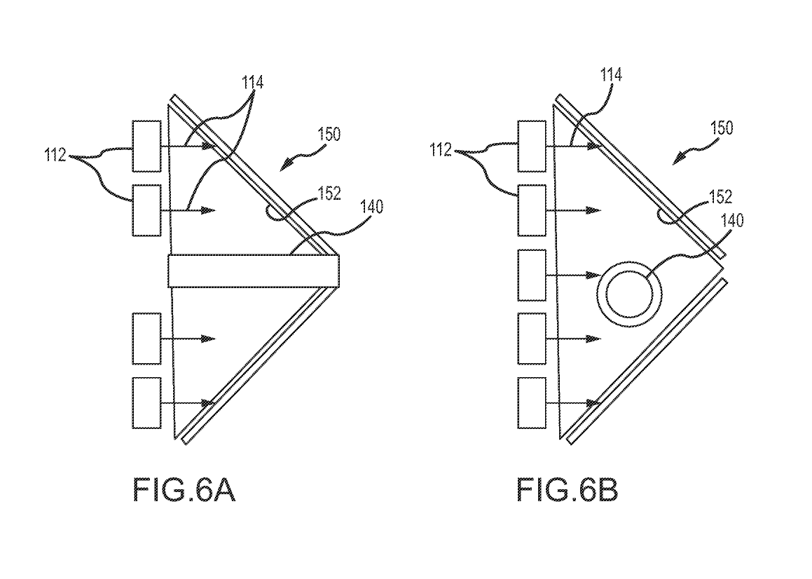

Two more rod-based pumping schemes that borrow from dye laser amplifier systems are illustrated in FIGS. 6A and 6B. FIG. 6B shows a variant of the Bethune cell, where a collimated beam entering the hypotenuse of a prism (solid or hollow) will reflect into the gain medium 140. The axis and diameter of the gain medium 140 is positioned so that there is even illumination from all sides. A variation is an axicon geometry (FIG. 6A), where the gain medium is along the axis of a conical reflector. While a specular reflecting surface is ideal for a collimated source, these geometries provide LED pumping with diffuse reflecting surfaces because they allow for input from 2D arrays of LEDs along with straightforward liquid cooling of the laser rod.

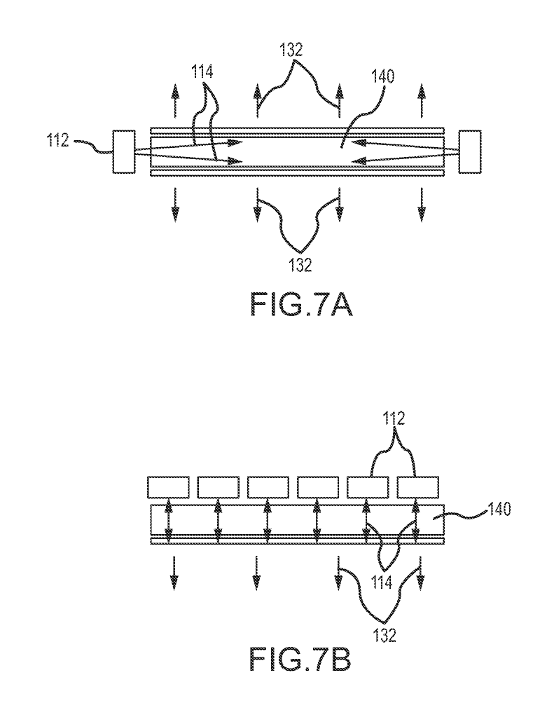

A third set of pumping schemes is illustrated in FIGS. 7A-B. In these embodiments of the device 100, LED arrays 112 emit LED emitted light 114 to gain medium 140, and cooling flow 132 is provided. The slab geometry has been used for both lamp and diode pumped systems. While liquid cooling is challenging owing to difficulties in obtaining a reliable fluid seal on the edges of the slab, conductive cooling on the broad faces can lead to efficient heat removal. The edge-pumped scenario (FIG. 7A) may result in fairly uniform pumping from both edges; confining the diffuse light with reflecting upper and lower surfaces further improves the uniformity. The face-pumped scheme (FIG. 7B) allows for easier power scaling with 2D LED arrays along one surface with conductive cooling on the other reflective surface. See FIGS. 7A-B.

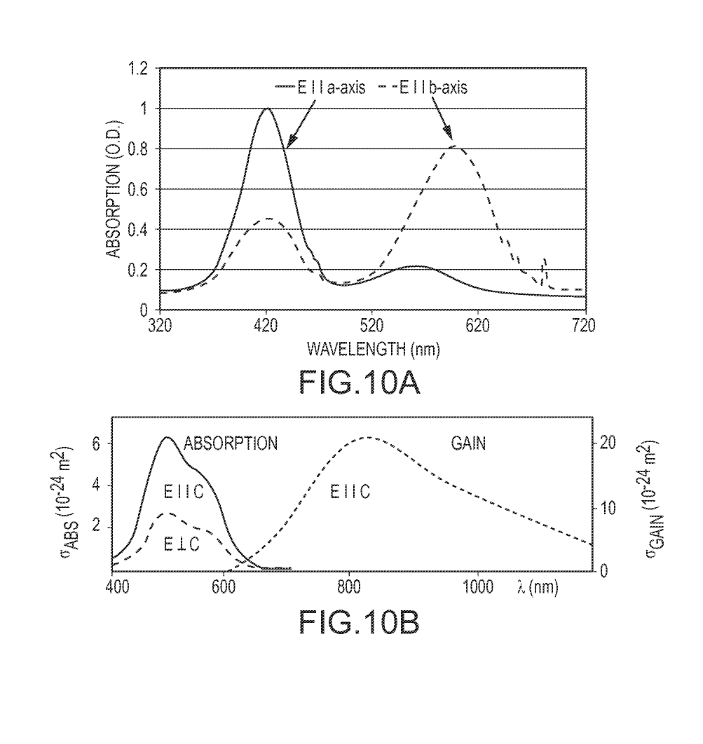

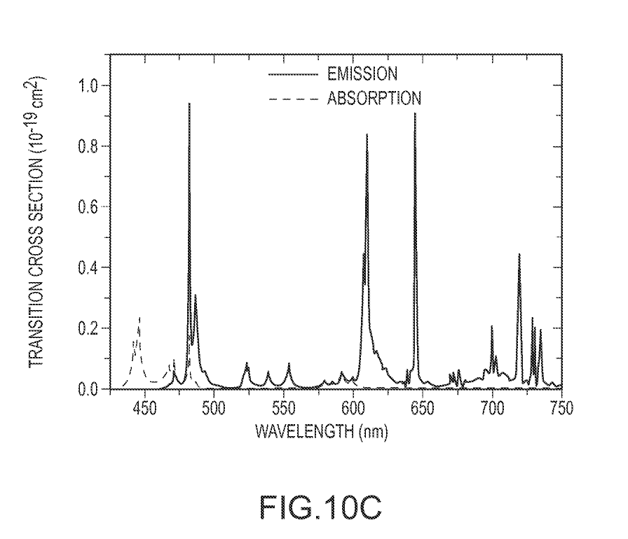

To analyze these pumping schemes, one may make use of the Zemax ray-tracing package, which can perform sequential and non-sequential tracing with optimization. Existing codes compute the saturated energy extraction for cylindrically symmetric pump and amplified beam distributions. A more general code allows for arbitrary 3D stored energy distributions, and other shapes of input laser beams. The gain modeling may be coupled with the propagation of the seed laser beam in the amplifier or oscillator resonator system, to account for gain guiding and thermal lensing effects on the amplified beam. The Comsol Multiphysics finite-element program may be used to assist in the modeling of the thermal loading of the crystal, as well as for the microchannel cooling designs. See FIGS. 10A-B.

### Estimates for Candidate Gain Media for LED Pumping

LEDs have a great potential for high energy output considering the cost that will continue to be driven lower by the immense market for efficient lighting. Embodiments of the invention use various gain media, and may be evaluated via the data with respect to LED operation at high current and short pulses. Seed lasers may be used to measure small signal gain, and either simple lasers (for the Ce:Nd:YAG crystal) or amplifiers designed and tested to evaluate the capabilities for energy extraction.

Ce:Nd:YAG The co-doped gain material in a valance +3 state has a large absorption coefficient (>3/cm) for pump light at 445 nm, enabling relatively small rod diameters and higher gains. Note that this co-doped combination is not limited to the host crystal YAG; other host media are, including but not limited to, vanadate (YVO4), YLF (yttrium aluminum fluoride), and various formulations of glass. In one embodiment, a single 1.2 mm² area LED with 50% EQE at 1000A/cm², the energy that can be emitted during the 230 μs lifetime of the Nd excited state is approximately 3.7 mJ. Consider a close-coupling geometry using a rod 3 mm in diameter and an array surrounding the rod on a 5 mm diameter circle, using arrays with an element size of 1.1 mm square mounted with a 21% fill factor. The number of LED elements would be approximately 100, delivering a total energy per pulse of 366 mJ. With an estimated pump transfer efficiency of 50%, 50% efficiency for extracting the stored energy and accounting for the Stokes shift (445/1064=0.42), the estimated output energy would be approximately 38 mJ. The estimated small-signal gain under these conditions would be 44/pass. Since this is likely too large for hold-off by a Q-switch, the same pump energy deposited into a larger diameter may be used. With sufficient cooling (the LEDs can be operated at high duty cycle) and a Q-switched and intracavity- doubled laser built around a pump head of this type would be very competitive with existing commercial lamp- and CW diode-pumped lasers (e.g. Quantronix, Photonics Industries, Coherent).

### Ce:Yb:YAG, Ce:Er:YAG

Cerium 3+ ions can also be co-doped with ytterbium and erbium, in YAG or other host media as noted above. Yb has its primary lasing band at approximately 1030 nm and Er lases near 1550 nm. Both gain media have gain over a sufficient bandwidth to support lasing and amplification of ultrashort pulses in the 100-200 fs duration range. The distinctive advantage of these two gain media is that the excitation of the Ce ions by the blue pump light is sufficiently high to simultaneously excite two neighboring gain atoms (Yb or Er). This process is known as upconversion and has been considered for solar applications. In the context of laser pumping, the capability of obtaining two excited atoms for one pump photon dramatically increases the gain and efficiency of the system. Yb and Er have long fluorescence lifetimes (approximately 2 ms and 9 ms, respectively), so they can effectively store pump energy, increasing the gain along with the output energy. The doping concentrations can be much higher than for Nd systems, which are more affected by quenching of the excited state with concentrations greater than 1%.

### Alexandrite

This crystal, which can support the amplification of broadband pulses has historically been superseded by Ti⁽³⁺⁾:sapphire, which has a broader bandwidth and a lower saturation fluence. Nevertheless, along the b-axis, the crystal can amplify over the 710-800 nm range. The absorption in this biaxial crystal depends strongly on the crystal axis (See FIG. 10A) but the strong peak in the blue for the a-axis overlaps well with available LED sources. There are also LEDs available in the yellow (˜590 nm) to overlap with the pump band along the b-axis.

Alexandrite has a relatively long fluorescence time (270 μs), approximately 85× that of Ti:sapphire. The large saturation fluence for the broadband transition (20 J/cm2) is close to or beyond the damage limit for pulsed operation (especially for stretched pulses <1 ns). Therefore careful amplifier design is necessary to obtain good energy extraction. With a 6.25 mm diameter by 100 mm long rod, a dense array with a 50% fill factor and 50% optical coupling efficiency can store up to 1.1 J of energy. Owing to the large saturation fluence, the small signal single-pass gain would be approximately 1.2 per pass. While this gain is low, it is sufficient for regenerative amplification

which would be able to efficiently extract the stored energy. The gain for alexandrite increases when it is operated at elevated temperature. The alexandrite gain module uses seed pulses from a Ti⁽³⁺⁾:sapphire oscillator.

Praseodymium-doped materials Pr 3+ ions are well-suited to pumping by blue pump sources (see FIG. 10C for the absorption spectrum). There is emission at several bands throughout the visible, notably near 480, 610, 640 and 700 nm. Direct LED pumping of Pr has a very favorable ratio of lasing photon energy to pump photon energy, especially for lasing on the shorter wavelength range. This makes it an attractive pump source for Ti:sapphire lasers. The fluorescence lifetime of Pr is approximately 40 μs. While this is much shorter than the gain media described above, the LEDs can be pulsed easily with a shorter pulse duration than flashlamps, and with sufficient coupling efficiency, efficient lasing is possible. The saturation fluence is approximately 4 J/cm2 at 480 nm. With 40% coupling efficiency from the LEDs to the laser rod

_Ti:sapphire

The absorption spectrum of Ti⁽³⁺⁾:sapphire is shown in FIG. 10B. As in alexandrite, polarized pumping will optimize the absorption efficiency. However, the peak absorption for the other polarization direction is 40% of the peak along the c-axis, which is sufficiently high that over two absorption lengths of the c-axis polarization, there is still a net 71% absorption of an unpolarized source. While direct diode pumping of Ti(³′):sapphire has been demonstrated with laser diodes at 445 nm, these diodes are available only as single TO- can packages of maximum 2W each. LED pumping with green light at the peak of the absorption curve is an attractive alternative to pumping this important gain material. The chief challenge in pulse pumping Ti⁽³⁺⁾:sapphire is the short fluorescence lifetime of 3.2 μs. In one embodiment, the thermal damage limits could be avoided by using a low duty cycle with short current pulses.

In one embodiment, LEDs are operated at a current density of 5000 A/cm² for a 3 μs duration and 3 kHz repetition rate. With a 5 mm square rod, 50 mm in length, pumped on 3 sides (a combination of both schemes shown in FIGS. 10A-B), approximately 290 LED elements can be used in a close-coupled geometry. If the EQE is 40%, the total pump energy emitted in the green in a 3 us pulse would be 56 mJ. (It is worth noting that a 50 mJ diode pumped, frequency-doubled Nd:YAG laser operating at 1 kHz costs over $100 k, and the LEDs are approximately $1 per element.) If polarized LEDs are used, the single-pass absorption efficiency for pumping on the sides would be 81%, while the LEDs pumping from the top would see lower absorption but could experience a double pass with a reflector on the non-pumped, cooled face. With 80% average optical transfer efficiency, and accounting for the photon energy ratio of seed to pump, the net stored energy available for extraction would be 19 mJ.

In one embodiment, performance of the LED-pumped laser device is increased by operation at cryogenic temperatures. In one embodiment, Cree Direct-Attach DA1000 LEDs, which use a bondpad-down architecture to mitigate resistance at the metallization attachment to the LED, are used. In another embodiment, new generation nanowire LEDs, such as those made by the Swedish company Glō, are used. Such nanowire LEDs are highly efficient because of the absence of impurities in the nanowires.

In one embodiment, a cryogenically-cooled amplifier module in which both the LED arrays and Ti⁽⁺³⁾:sapphire crystal are operated near liquid nitrogen temperature is employed. This amplifier uses seed pulses from an existing kHz repetition rate ultrafast Ti:sapphire system.

In one embodiment, the LED-pumped laser device employs other gain media known to those skilled in the art, comprising Nd:Cr:GSGG, Nd:YVO4, Nd:GdVO4, Nd:KGW, Cr:Sapphire (a.k.a “Ruby”), Cr:LiSAF, Cr:YAG, Cr:Forsterite, Er:YLF, and Nd:glass, as well as other solid state materials that exhibit a spontaneous emission of photons as a result of a population inversion initiated by gain medium excitement with absorption-matching incoherent monochromatic sources such as arrays of LEDs.

A purpose of the invention is to replace the conventional flash lamp or flash lamps with LED's and LED arrays. Standard flash lamp drivers use a combination of Resistance (R), Inductance (L), and Capacitance (C) to control the pulse current to the flash lamp. One skilled in the art understands that with flash lamp technology, one has to be careful in applying high current suddenly to the flash lamp. If the impulse current is too large or too fast the flash lamp may explode or reduce the flash lamp life. Because the flash lamp is based on a gaseous plasma, one cannot get a fast rise time of light without special flash lamp designs and circuitry, thereby significantly increasing the system cost.

In the invention, the high intensity flash lamps are replaced with very high intensity LEDs that are being driven by a programmable pulse current generator.

In the prior art, such as U.S. Pat. No. 7,522,651 to Luo, conventional LEDs and electrical drives are employed. For example, typically linear arrays of 1×n LEDs are used, resulting in optical droop increasing as the current is increased (See FIGS. 11A-B.) This limits the energy that can be extracted from the laser. FIG. 11A depicts a graph of LED output power with time, according to the prior art. FIG. 11B depicts a graph of emitted LED pump energy with time, according to the prior art.

In contrast, the invention provides a superior way of pumping by eliminating the optical droop. This entails making the LED array n×m or a 2-dimensional array. FIG. 11C depicts a graph of emitted LED output power with time, and LED current with time, of an LED pumped laser device according to the embodiment of FIG. 4. From examining FIG. 11C one understands that the disclosed method has eliminated both the optical and electrical droop that has plagued the prior art and has limited output to micro joules of laser energy. The invention actually produces laser energy in the 10's of mill joules and achieves the highest output energy to date for LED pumped solid-state lasers.

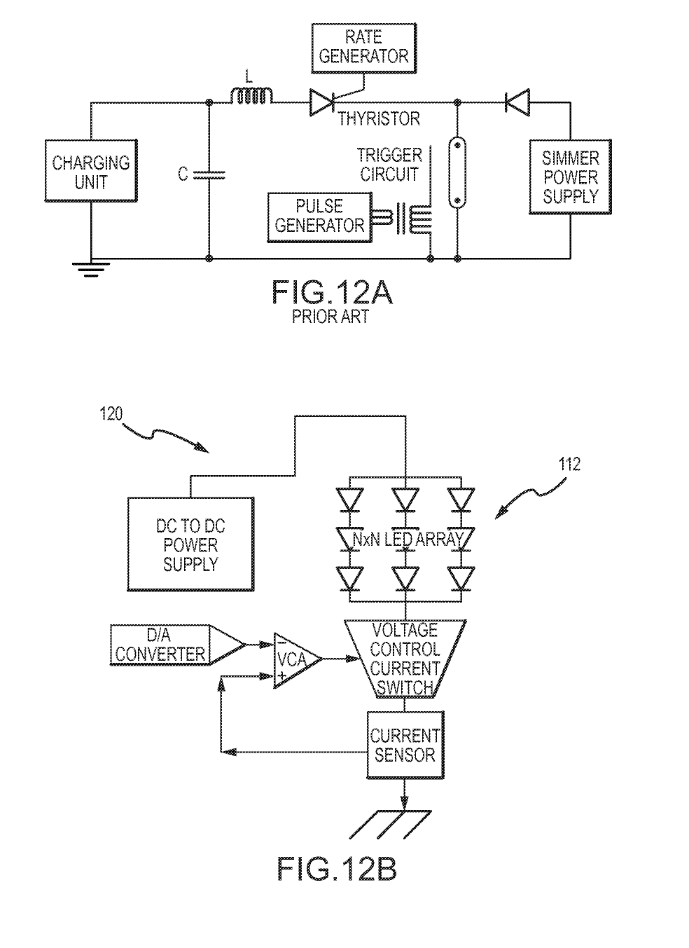

FIG. 12A depicts a conventional flash lamp circuit, according to the prior art. In this disclosure, such a circuit is replaced by the driving circuit element 112, as part of an LED pumped laser device according to the embodiment of FIG. 4. The driving circuit element 112 drives the LED arrays 112, eliminating several of the major problems of conventional flash lamp and prior art LEDs. For example, flash lamps convert up to 50% of their electrical energy into light and then only a small percentage of that light into useful pump light (to where only up to 5% of the electrical is converted into optical pump light.) Flash lamps also have a very short lifetime of up to 500 hours before requiring replacement. The invention may provide up to 70% of the electrical energy converted into optical energy; furthermore, a spectral bandwidth of the LED of 50 nm ensures that at least 90% of the light is being absorbed by the laser material. Also, the lifetime of the LED array 112 can be up to 50,000 hours before it needs replacement.

The conventional prior art does not address pumping at various vibronic gain crystals; the prior art does not realize that the vibronic gain crystals are polarization sensitive. Therefore, if one pumps with the current flash lamp or current LEDs, the incoherent pump light is unpolarized and 50% of the light is not being used as for pumping. In contrast, the invention utilizes high power LEDs that are linearly polarized, which, by generating linear polarized light from the LED's themselves, all or most of the LED pump light is available to excite the vibronic gain crystals, such as Ti: Sapphire.

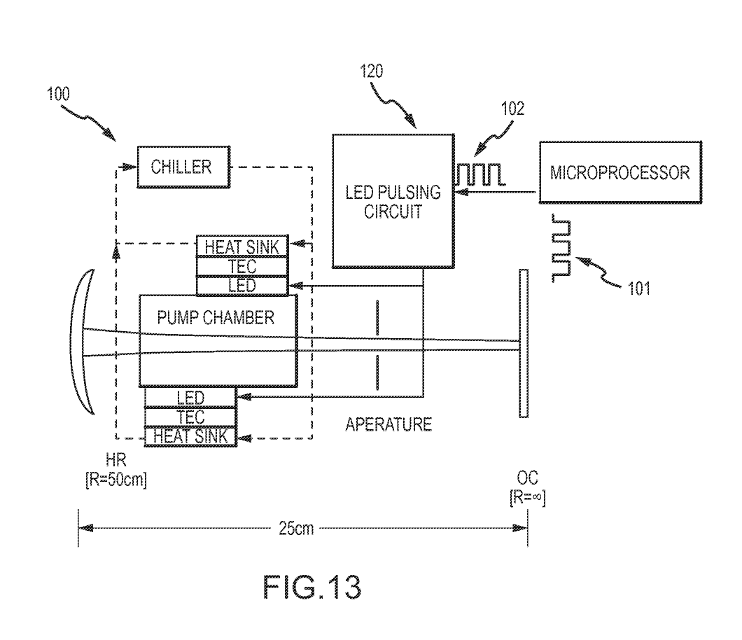

FIG. 13 depicts a block diagram of the LED pumped laser device according to another embodiment, using the driving circuit element of FIG. 12B. In the embodiment of the device 100 of FIG. 13, a microprocessor drives or controls by electronic pre drive pulse or pulses 101 to a LED pulsing circuit (aka LED driving circuit) 120 which in turn drives one or more LEDs 110 and/or LED arrays 112 with a large current pulse or pulses 102. Each LED 110 or LED array 112 is positioned near a thermo electric cooler (aka cooler or “TEC”) 130 and also a heat sink. The pump chamber holds the gain medium 140. A chiller (aka cooler) 130 is in communication with the heat sinks.

In one embodiment, a novel glass material is used in the device 100. The glass material eliminates or mitigates polarization issues and also solves the thermo-mechanical issues that have plagued glass lasers from operating at high rep rates. The glass is doped with Ti(III)(+3) ions and has a longer lifetime than Ti(III):Sapphire and almost twice the emission cross section. The lifetime increases from 3.6 microseconds in Sapphire to 170 microseconds in glass at 300K and improves further, at 77K liquid nitrogen temperatures, to 2 milliseconds. This is very important because it reduces the pump energy requirements by almost two orders at room temperature and 3 to 4 orders at liquid nitrogen temperature. The emission wavelength shifts blue-wards by about 190 nm so as to lases at 600 nm-800 nm instead of the 800 nm-1000 nm. Furthermore, the absorption in the blue is near UV, thus improved pumping is achieved. Also, because of the glass containment, no polarization sensitivity is present and thermo-mechanical properties much like sapphire are achieved, thereby allowing running at high energy high rep rates that may be tunable to allow generation of ultra short laser pulses.

It should, however, be appreciated that the present disclosure may be practiced in a variety of ways beyond the specific detail set forth herein. Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD®FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

What is claimed is:

1. A solid-state laser device, comprising:
a gain medium;
a plurality of LEDs in optical communication with the gain medium to excite the gain medium, the plurality of LEDs arranged in an LED array;
a driving circuit to energize the LED array; and
a cooler to reduce the temperature of the LED array;
wherein the gain medium is pumped by the LED array to emit a laser light.

2. The device of claim 1, wherein active ions in the solid-state gain medium are selected from the group consisting of Ce⁽⁺³⁾, Nd⁽⁺³⁾, Ce⁽⁺³⁾, Yb⁽⁺³⁾, Ce⁽⁺³⁾, Er⁽⁺³⁾, Pr⁽⁺³⁾, Ti⁽³⁺⁾ and Cr⁽⁺³⁾.

3. The device of claim 1, wherein the LED array comprises semi-polar LEDs.

4. The device of claim 1, wherein at least a portion of the laser device operates under cryogenic conditions.

5. The device of claim 1, further comprising a cryogenically-cooled amplifier module.

6. The device of claim 1, wherein the driving circuit outputs square electrical current pulses to energize the LED array.

7. The device of claim 1, wherein the cooler is mounted to a back surface of the LED array.

8. The device of claim 1, wherein the cooler is a microchannel cooling device interconnected to a rear surface of the LED array.

9. The device of claim 1, wherein the plurality of LEDs emit linearly polarized light.

10. The device of claim 1, wherein the LED array is a two-dimensional array.

11. The device of claim 1, wherein the device does not use a flash lamp.

12. An LED pumped laser system comprising:
a solid-state gain medium wherein active ions in the gain medium are selected from the group consisting of Ce⁽⁺³⁾, Nd⁽⁺³⁾, Ce⁽⁺³⁾, Yb⁽⁺³⁾, Ce⁽⁺³⁾, Er⁽⁺³⁾, Pr⁽⁺³⁾, Ti⁽³⁺⁾ and Cr⁽⁺³⁾;
a plurality of LEDs arranged in a 2-dimensional planar LED array in optical communication with the gain medium to excite the gain medium;
a driving circuit devoid of flash lamps to energize the LED array;
a cooler to reduce the temperature of the LED array, the cooler comprising a thermoelectric cooler and a microchannel cooler;
wherein the LEDs emit linearly polarized light; and
wherein the gain medium is pumped by the LED array to emit a laser light.

13. The system of claim 12, further comprising a cryogenically-cooled amplifier module.

14. The system of claim 12, wherein the driving circuit outputs square electrical current pulses to energize the LED array.

15. The system of claim 14, wherein the cooler is mounted to a back surface of the LED array.

16. The system of claim 15, wherein the cooler is a microchannel cooling device interconnected to a rear surface of the LED array.

17. A method of generating laser light comprising:
providing a gain medium;
arranging a plurality of LEDs in a 2-dimensional planar LED array in optical communication with the gain medium to excite the gain medium;
driving the LED array with a driving circuit to energize the LED array;
providing a cooler in communication with the LED array to cool the LED array;
emitting linearly polarized light by the plurality of LEDs; and
pumping the gain medium with the emitted linearly polarized light;
wherein laser light is emitted.

18. The method of claim 17, wherein active ions in the gain medium are selected from the group consisting of Ce⁽⁺³⁾, Nd⁽⁺³⁾, Ce⁽⁺³⁾, Yb⁽⁺³⁾, Ce⁽⁺³⁾, Er⁽⁺³⁾, Pr⁽⁺³⁾, Ti⁽³⁺⁾ and Cr⁽⁺³⁾.

19. The method of claim 18, wherein the driving circuit outputs square electrical current pulses to energize the LED array.

20. The method of claim 19, further comprising a cryogenically-cooled amplifier module.
